(19) United States
(12) Patent Application Publication
(10) Pub. No.: US 2009/0262751 A1
(43) Pub. Date: Oct. 22, 2009

(54) CONTROLLING NETWORK COMMUNICATIONS USING SELECTIVE JAMMING

(76) Inventor: Troy D. Rockwood, Thousand Oaks, CA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/103,914

(22) Filed: Apr. 16, 2008

(51) Int. Cl. H04J 3/02

(52) U.S. Cl. 370/462

(57) ABSTRACT

In one aspect, a method includes monitoring a network including nodes, receiving a first signal from a first node and determining whether the first node is authorized to transmit the first signal. The first node is configured to cease transmission if the first node detects another node is also transmitting. The method also includes broadcasting a second signal if the first node is not authorized to transmit the first signal and ceasing transmission from the first node based on receipt of the second signal.

### BACKGROUND

In a shared network with multiple users sharing the same frequency, it is desirable to have only one user transmit data at a time. For example, if one user transmits data at the same time another user is transmitting data, collisions occur and data is generally corrupted and lost.

Medium Access Control (MAC) protocols are rules by which network nodes cooperate with one another. The most widely deployed commercial MAC protocols are contention-based. That is, each node in the network must decide individually if it is permitted to transmit.

Quality of Service (QoS) in networks is a specific guarantee on the type of network service that can be expected at individual nodes or groups of nodes. In some examples, QoS is measured in delay or bandwidth. QoS may be implemented at any layer of an Open Systems Interconnection (OSI) networking protocol stack including the MAC protocol layer. At the MAC protocol layer QoS is used to ensure specific access privileges to a shared medium (such as the electromagnetic spectrum).

### SUMMARY

In one aspect, a method includes monitoring a network including nodes, receiving a first signal from a first node and determining whether the first node is authorized to transmit the first signal. The first node is configured to cease transmission if the first node detects another node is also transmitting. The method also includes broadcasting a second signal if the first node is not authorized to transmit the first signal and ceasing transmission from the first node based on receipt of the second signal.

In another aspect, an article includes a machine-readable medium that stores executable instructions that cause a machine to monitor a network comprising nodes; receive a first signal from a first node and determine whether the first node is authorized to transmit the first signal. The first node is configured to cease transmission if the first node detects another node is also transmitting. The machine-readable medium also stores executable instructions that cause a machine to broadcast a second signal if the first node is not authorized to transmit the first signal. The first node ceases transmission based on receipt of the second signal.

In a further aspect, an apparatus includes circuitry to monitor a shared-medium-access network including nodes. The shared-medium-access network is a contention-based network. The apparatus also includes circuitry to receive a first signal from a first node and to determine whether the first node complies with a Quality of Service parameter. The first node is configured to cease transmission if the first node detects another node is also transmitting based on a backoff mechanism. The apparatus also includes circuitry to broadcast a second signal if the first node does not comply with a Quality of Service parameter. The first node ceases transmission based on receipt of the second.

### DESCRIPTION OF THE DRAWINGS

FIG. 1 is a diagram of a communication network having nodes.

FIG. 2 is a graph depicting a transmission profile.

FIG. 3 is a flowchart of an example of a process to control network communications using selective jamming.

FIG. 4 is a block diagram of an example of a special node on which the process of FIG. 3 may be implemented.

### DETAILED DESCRIPTION

A goal of network communications scheduling is to ensure that only one network node communicates at a time. If one node transmits data at the same time another node is transmitting data, collisions, which corrupts the data, will occur at a receiving node which is in range of both transmitting nodes. In one particular example, described herein are methods and techniques to control network communications by selectively jamming nodes that are not authorized to transmit by exploiting a backoff mechanism at the nodes. The techniques described herein solve a long felt need in the industry to implement Quality of Service (QoS) in a contention-based and shared access network that enables non-cooperative nodes to be managed.

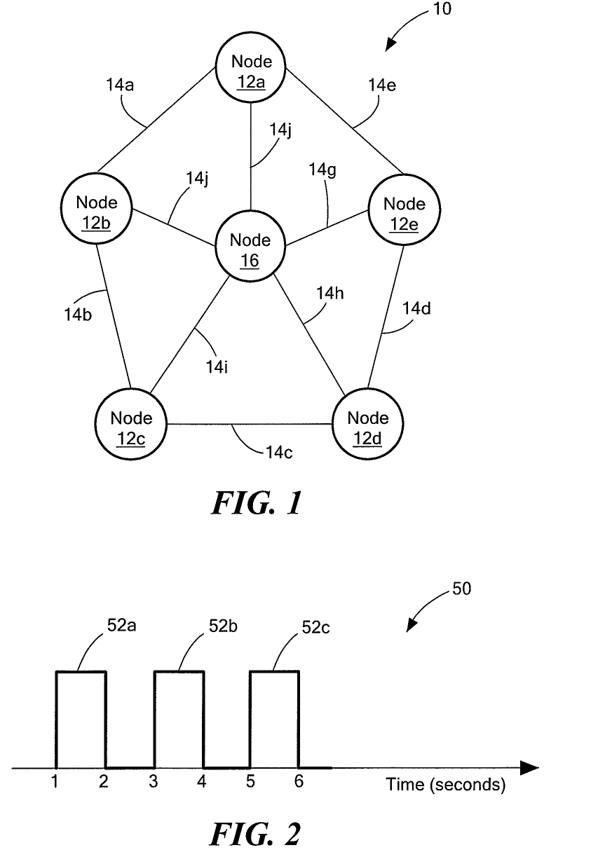

Referring to FIG. 1, a communications network 10 includes nodes 12a-12e (e.g., a first node 12a, a second node 12b, a third node 12c, a fourth node 12d and a fifth node 12e) and a special node 16. In one example, the nodes 12a-12e, 16 are network routers. In another example, the nodes 12a-12e, 16 are wireless radios.

The nodes 12a-12e, 16 are connected by links 14a-14j representing that the two nodes are within transmit/receive range of each other. In one example, the links 14a-14j are wireless links. In another example, the links 14a-14j are wired links. In another example, links 14a-14j may be a combination of wireless and wired links. The communications network 10 may be any shared medium. In one example, the communications network 10 may be part of a larger network (not shown).

Each of the node 12a-12e, 16 uses a backoff technique to prevent two nodes from transmitting at the same time by requiring each node that is transmitting simultaneously to wait a respective random amount of time before retrying transmission. For example, if a node detects another node transmitting, each will backoff (stop transmitting) for a random period of time. In one example, during backoff each node waits a random amount of time between zero and 1 second. Since each node determines a random backoff time independently each node generally determines a different backoff time.

One example of backoff is an exponential backoff. For example, in an exponential backoff, if two nodes detect each other each node waits an initial backoff period determined randomly between 0 and a fixed number. If a second consecutive collision occurs, the backoff period is zero and a number twice the fixed number. In one particular example, if the initial backoff is between 0 and 1 second, after a second consecutive collision the backoff is determined to randomly between 0 and 2 seconds and for n consecutive collisions is determined to be randomly between zero and 2ⁿ⁻¹ seconds.

In one particular example, the special node 16 controls the network communications of network 10 by controlling the nodes 12a-12e. The special node 16 can ensure the nodes 12a-12e are following QoS criteria by exploiting each nodes 12a-12e backoff mechanism. For example, if a sender node is transmitting when it is not authorized to transmit, the special node 16 will start broadcasting a signal and the sender node receives the signal broadcasted and will cease transmitting based on the backoff mechanism. In one example, the signal broadcasted by the special node 16 need not be to any specific node. In another example, the signal broadcasted by the special node 16 need not be intelligible to any node, but the broadcasted signal just needs to “walk on top of” the signal transmitted by the sender node that is not authorized to transmit so that the sender node detects the broadcasted signal by the special node to perform backoff. In one example, the nodes 12a-12e are in the collision domain of the node 16 because each of the nodes 12a-12e is in range or connected to the node 16.

FIG. 2 includes an example of a transmission profile 50 conforming to QoS criteria. In one example, the special node 16 determines whether the sender node is broadcasting within its transmission profile 50. For example, the sender node may only transmit during the time periods 52. If the sender node attempts to transmit outside the time periods 62, the special node 16 broadcasts a signal to the sender node thereby forcing the sender node to backoff. The transmission profile may be constructed to conform to QoS. In one particular example, a sender node must wait at least a predetermined amount of time before transmitting again. For example, in FIG. 2, a sender node must wait at least one second before transmitting again. If it does not wait at least one second, the sender 16 sends a signal to the sender node to activate backoff.

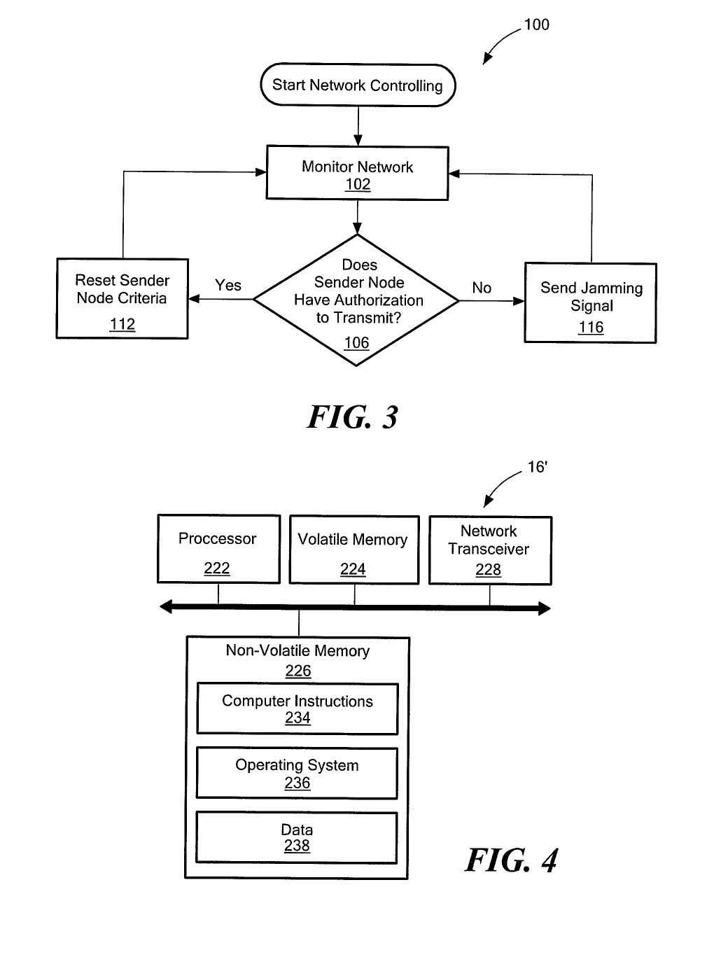

Referring to FIG. 3, a process 100 is an example of a process to control network communications in network 10. In one example, the special node 16 performs process 100 to control the network nodes 12a-12e. The special node 16 monitors the network 10 (122). For example, the special node 16 monitors the communications from the nodes 12a-12e. The special node 16 determines if a sender is authorized to transmit (126). For example, the special node 16 determines if a node 12a-12e is authorized to transmit based on a QoS criteria. For example, the special node 16 determines if the node is transmitting within its transmit profile 50. In another example, the special 16 determines if the sender node has waited at least a minimum amount of time before transmitting.

If the sender is not authorized to transmit, the special node 16 jams the sender by broadcasting a signal (116). The sender node detects another signal and performs backoff (i.e., the sender node stops transmitting for a random period of time).

If the sender is authorized to transmit, the special node 16 resets the sender node criteria. For example, if the criteria for the sender node include waiting at least one full second before transmitting again, a timer (not shown) is reset to zero.

Referring to FIG. 4, the special node 16 may be configured as a special node 16′, for example. The network node 16′ includes a processor 222, a volatile memory 224, a non-volatile memory 226 (e.g., hard disk) and a network transceiver 228. The non-volatile memory 226 stores computer instructions 234, an operating system 236 and data 238. The transceiver 228 is used to communicate with the other network nodes. In one example, the computer instructions 234 are executed by the processor 222 out of volatile memory 224 to perform process 100.

Process 100 is not limited to use with the hardware and software of FIG. 4; it may find applicability in any computing or processing environment and with any type of machine or set of machines that is capable of running a computer program. Process 100 may be implemented in hardware, software, or a combination of the two. Process 100 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 100 and to generate output information.

The system may be implemented, at least in part, via a computer program product, (e.g., in a machine-readable storage device), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform process 100. Process 100 may also be implemented as a machine-readable storage medium, configured with a computer program, where upon execution, instructions in the computer program cause the computer to operate in accordance with process 100.

The processes described herein are not limited to the specific embodiments described herein. In another example, the process 100 is not limited to the specific processing order of FIG. 3, respectively. Rather, any of the processing blocks of FIG. 3 may be re-ordered, combined or removed, performed in parallel or in serial, as necessary, to achieve the results set forth above.

The processing blocks in FIG. 3 associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Elements of different embodiments described herein may be combined to form other embodiments not specifically set forth above. Other embodiments not specifically described herein are also within the scope of the following claims.

What is claimed is:

1. A method, comprising:
monitoring a network comprising nodes;
receiving a first signal from a first node;
determining whether the first node is authorized to transmit the first signal, the first node being configured to cease transmission if the first node detects another node is also transmitting; and
broadcasting a second signal if the first node is not authorized to transmit the first signal; and
ceasing transmission from the first node based on receipt of the second signal.

2. The method of claim 1 wherein monitoring a network comprises monitoring a shared-medium access network.

3. The method of 2 wherein monitoring a shared network comprises monitoring a contention-based network.

4. The method of claim 1, further comprising detecting a third signal from a second node authorized to transmit,
wherein the first node does not detect the third signal.

5. The method of claim 1 wherein ceasing transmission comprises ceasing transmission for a period of time.

6. The method of claim 5 wherein ceasing transmission for a period of time comprises ceasing transmission for a period of time determined randomly.

7. The method of claim 5 wherein ceasing transmission for a period of time comprises ceasing transmission for a period of time based on a backoff mechanism.

8. The method of claim 1 wherein determining whether a first node is authorized to transmit comprises determining whether the first node violates a Quality of Service parameter.

9. The method of claim 8 wherein determining whether the first node complies with a Quality of Service parameter comprises determining whether the first node is transmitting within an approved transmission profile.

10. The method of claim 8 wherein determining whether the first node complies with a Quality of Service parameter comprises determining whether the first node has waited a predetermined amount of time between transmissions.

11. An article comprising a machine-readable medium that stores executable instructions that cause a machine to:
monitor a network comprising nodes;
receive a first signal from a first node;
determine whether the first node is authorized to transmit the first signal, the first node being configured to cease transmission if the first node detects another node is also transmitting; and
broadcast a second signal if the first node is not authorized to transmit the first signal,
wherein the first node ceases transmission based on receipt of the second signal.

12. The article of claim 1 wherein instructions causing a machine to monitor a network comprises instructions causing a machine to monitor a shared-medium access network which is a contention-based network.

13. The article of claim 11, further comprising instructions causing a machine to detect a third signal from a second node authorized to transmit, wherein the first node does not detect the third signal.

14. The article of claim 11 wherein the first node ceases transmission based on receipt of the second signal comprises the first node ceasing transmission for a period of time.

15. The article of claim 14 wherein the first node ceases transmission for a period of time comprises the first node ceasing transmission for a period of time determined randomly.

16. The article of claim 14 wherein the first node ceases transmission for a period of time comprises the first node ceasing transmission for a period of time based on a backoff mechanism.

17. The article of claim 11 wherein instructions causing a machine to determine whether a first node is authorized to transmit comprises instructions causing a machine to determine whether the first node violates a Quality of Service parameter.

18. The article of claim 17 wherein instructions causing a machine to determine whether the first node complies with a Quality of Service parameter comprises instructions causing a machine to determine whether the first node is transmitting within an approved transmission profile.

19. The article of claim 17 wherein instructions causing a machine to determine whether the first node complies with a Quality of Service parameter comprises instructions causing a machine to determine whether the first node has waited a predetermined amount of time between transmissions.

20. An apparatus comprising:
circuitry to:
monitor a shared-medium-access network comprising nodes, the shared-medium-access network being a contention-based network;
receive a first signal from a first node;
determine whether the first node complies with a Quality of Service parameter, the first node being configured to cease transmission if the first node detects another node is also transmitting based on a backoff mechanism;
broadcast a second signal if the first node does not comply with a Quality of Service parameter; and
wherein the first node ceases transmission based on receipt of the second signal.

21. The apparatus of claim 20 wherein the circuitry comprises at least one of a processor, a memory, programmable logic and logic gates.

22. The apparatus of claim 20 wherein circuitry to determine whether the first node complies with a Quality of Service parameter comprises circuitry to determine whether the first node is transmitting within an approved transmission profile.

23. The apparatus of claim 20 wherein circuitry to determine whether the first node complies with a Quality of Service parameter comprises circuitry to determine whether the first node has waited a predetermined amount of time between transmissions.
